(19) United States
(12) Patent Application Publication
(10) Pub. No.: US 2016/0337743 A1
(43) Pub. Date: Nov. 17, 2016

(54) APPARATUS AND METHODS FOR ATTENUATION OF AN AUDIO SIGNAL

(71) Applicant: William Chester Neeley, Melbourne, FL (US)

(72) Inventor: William Chester Neeley, Melbourne, FL (US)

(21) Appl. No.: 14/930,814

(22) Filed: Nov. 3, 2015

Related U.S. Application Data
(60) Provisional application No. 62/159,799, filed on May 11, 2015.

(51) Int. Cl. H04R 1/10

(52) U.S. Cl. CPC H04R 1/1041; H04R 2430/01

(57) ABSTRACT

The present invention provides apparatus and methods for attenuating audio based on sensed motion in a predefined area proximate to one or both the user and the audio source. The present invention is particularly useful to users who may startle easily, allowing a user to listen with headphones or earbuds without constantly being concerned that someone is going to “appear out of nowhere” and startle the user. The present invention may also be useful in the event of an emergency, where motion may attenuate the audio and allow a user to be more conscientious of their immediate surroundings.

### CROSS-REFERENCE TO RELATED APPLICATION

This application claims priority to and the full benefit of U.S. Provisional Patent Application Ser. No. 62/159,799, filed May 11, 2015, and titled “APPARATUS AND METHODS FOR ATTENUATION OF AN AUDIO SIGNAL”, the entire contents of which are incorporated herein by reference.

### FIELD OF THE DISCLOSURE

The present disclosure relates to methods and apparatus for interrupting audio output of an audio device based on motion detection. More specifically, the present disclosure describes an interruption system that may recognize an approach of a nonuser and attenuate the audio output from an audio source to alert a user of the approach.

### BACKGROUND OF THE DISCLOSURE

Currently, the U.S. headphone market is estimated at two billion dollars and the global market at eight billion dollars. Various sources indicate an annual growth rate of ten percent. One market report cites U.S. sales of headphones in 2014 of 70 million units, wherein the market consists of everything from $5 earbuds to $300 or more for headphones.

Originally, individuals would listen to audio either through the radio in their automobiles or in their homes, or through audio devices, such as a gramophone or boom box, that would project audio throughout a designated area. Headphones were devised as a way to serve a growing need for portable audio devices and to ensure the privacy of those that wanted to listen to those audio devices and, as a corollary, not expose others to this audio. As an alternative to something like a boom box or loudspeaker, people had the option to use portable audio devices, such as a Sony Walkman or Apple iPod, in a variety of different capacities. For example, people could now listen to audio during their commute, during a run, or while traveling.

As different wants developed, so too did the headphone market begin to cater to these desires. From over-the-ear headphones for home experiences or ear buds for the more mobile listener, headphones have changed to meet these needs. However, these headphones typically cater to one specific purpose—listening to audio—and do not allow for a mixture between interacting with the real world as a part of everyday life while also facilitating a quick resumption to the aural headphone experience. The current headphone market also does not allow users to protect themselves in case of an emergency or allow them to take stock of or react to their environment should the need arise.

### SUMMARY OF THE DISCLOSURE

Accordingly, the present invention provides apparatus and methods for interrupting audio output of an audio device based on motion detection. More specifically, the present disclosure describes an interruption system that may recognize an approach of a nonuser and attenuate the audio output from an audio source to alert a user of the approach.

In some embodiments, an interruption system with a motion sensor may comprise an interruption device configured to attenuate an audio output signal of an electronic device, wherein the attenuation affects the audio output signal independent from the electronic device; and a first motion sensor configured to detect motion within a predefined distance of the first motion sensor and configured to transmit a motion notification to the interruption device, wherein the motion notification causes the interruption device to attenuate the audio output signal.

In some aspects, the interruption device may comprise a receiver, and the first motion sensor may comprise a transmitter. In some aspects, a user may define configuration settings of the interruption system. In some embodiments, a level and duration of the attenuation of the audio output signal may comprise an adjustable setting. In some aspects, the interruption device may further comprise a manual audio control configured to manually attenuate the audio output signal of the electronic device, wherein the manual attenuation affects the audio output signal independent from the electronic device, and wherein the manual audio control overrides the attenuation prompted by the motion notification.

In some embodiments, the interruption device may comprise a status indicator, wherein the status indicator indicates a predefined event. For example, the status indicator may comprises an audio indicator configured to interject a second audio signal into the audio output signal based on an occurrence of the predefined event; a visual indicator configured to provide a visual cue based on an occurrence of the predefined event; or a vibration device configured to vibrate based on an occurrence of the predefined event.

In some aspects, the interruption device may be integrated into a 3.5 mm headphone extension cable. In some embodiments, the interruption device may be integrated into headphones configured to receive the audio output signal of the electronic device. In some implementations, the attenuation may occur inline with the audio output signal and/or wirelessly from the electronic device. In some aspects, the interruption device may be integrated into the electronic device, such as a smartphone.

In some implementations, the interruption system may further comprise a second motion sensor configured to detect motion within a predefined distance of the second motion sensor and configured to transmit a second motion notification to the interruption device, wherein the second motion notification may cause the interruption device to attenuate the audio signal.

In some embodiments, an interruption system with a sensor may comprise an interruption device configured to attenuate an audio output signal of an electronic device, wherein the attenuation affects the audio output signal independent from the electronic device; and a first sensor configured to detect one or more of motion, audio, pressure, or light within a predefined distance of the first sensor and configured to transmit a notification to the interruption device, wherein the notification causes the interruption device to attenuate the audio output signal.

In some embodiments, the interruption device may comprise a receiver, and the first sensor may comprise a transmitter. In some implementations, the interruption device may be integrated into the electronic device. In some embodiments, the interruption device may further comprise a manual audio control configured to manually attenuate the audio output signal of the electronic device, wherein the manual attenuation may affect the audio output signal independent from the electronic device, and wherein the manual audio control may override the attenuation prompted by the notification.

In some aspects, the interruption system may further comprise a second sensor configured to detect one or more of motion, audio, pressure, or light within a second predefined distance of the second sensor and configured to transmit a second notification to the interruption device, wherein the second notification may cause the interruption device to attenuate the audio output signal. In some embodiments, the first sensor and the second sensor may detect a same set of one or more of motion, audio, pressure, or light. In some aspects, the first sensor and the second sensor may detect a different set of one or more of motion, audio, pressure, or light.

In some aspects, a user may define the configuration settings of the first sensor. In some embodiments, a manufacturer may define the configuration settings of the first sensor. In some embodiments, a user may define the configuration settings of the first sensor and the second sensor, wherein the first sensor and the sensor may be configurable separately.

In some embodiments, the interruption device may comprise a status indicator, wherein the status indicator may indicate a predefined event. In some aspects, the status indicator may comprise an audio indicator configured to interject a second audio signal into the audio output signal based on an occurrence of the predefined event; a visual indicator configured to provide a visual cue based on an occurrence of the predefined event; or a vibration device configured to vibrate based on an occurrence of the predefined event.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates an exemplary interruption system.

FIG. 2 illustrates an exemplary wireless interruption system.

FIG. 3 illustrates an exemplary interruption system scenario.

FIG. 4 illustrates aspects of controller hardware useful for implementing the present invention as a block diagram.

FIG. 5 illustrates a block diagram of an exemplary embodiment of a mobile device.

FIG. 6A illustrates an exemplary circuit schematic for implementing the present invention.

FIG. 6B illustrates an exemplary circuit schematic for implementing the present invention.

FIG. 6C illustrates an exemplary circuit schematic for implementing the present invention.

### DETAILED DESCRIPTION

The present invention provides apparatus and methods for attenuating audio based on sensed motion in a predefined area proximate to a motion sensor, which, in some embodiments, may be proximate to one or both the user and the audio source. The present invention is particularly useful to users who may startle easily, allowing a user to listen with headphones or earbuds without constantly being concerned that someone is going to “appear out of nowhere” and startle the user.

The device may be useful for users who may enjoy listening to music with headphones or earbuds but may have to forgo it or listen at a lowered that desired volume in order to remain aware of their surroundings. The device may also be useful for users who want or need to have music playing somewhat loudly through loudspeakers but also need to be responsive to others. For example, the environments may range from home settings to offices to small retail settings to recording studios.

### Glossary

Audio: as used herein refers to a sound frequency and amplitude suitable for perception by a human being. Generally, Audio is between about 20 and 20,000 Hz. A threshold of sound detectable by a human being is generally reported as the RMS sound pressure of 20 micropascals, or 0.98 pW/m2 at 1 atmosphere and 25° C.

Headphones: as used herein refers to any personal speakers configured to provide audio to an individual. In some embodiments, headphones may comprise electroacoustic transducers that convert an electrical signal to a corresponding sound to the user, such as through the ear or bone transduction.

Interruption: as used herein refers to any effect on the audio output from a device. For example, a partial or full attenuation of an audio signal. In some embodiments, the attenuation may be combined with an introduction of a separate audio output. The separate audio output source may be the same or different device that is being interrupted.

Motion Sensor: as used herein refers to a sensor configured to remotely detect motion of a person or object in a predefined area proximate to the motion sensor, in contrast to proximately to the audio interruption device.

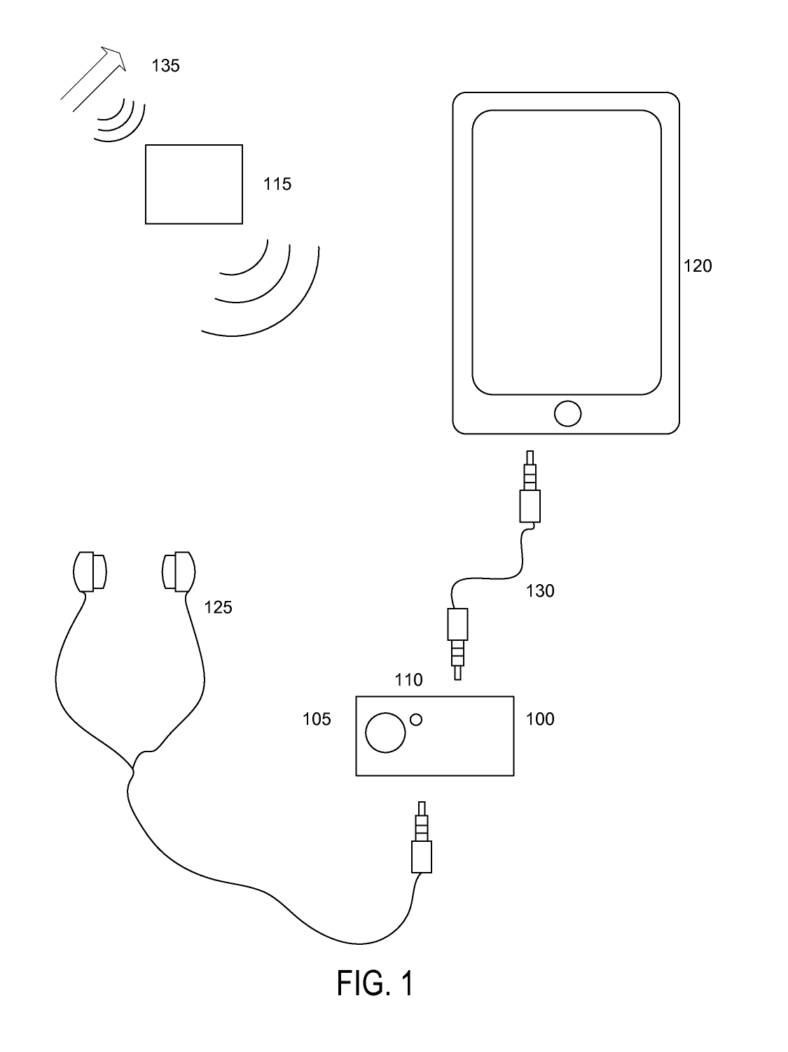

Referring now to FIG. 1, an exemplary interruption system with motion sensor 115 is illustrated. In some embodiments, an interruption system may comprise an audio interruption device 100 and a paired motion sensor 115, wherein the motion sensor 115 may transmit a signal to the audio interruption device 100 when motion 135 is detected, according to the programmed settings. In some embodiments, the audio interruption device 100 may be connected to an audio source 120, such as, for example, a smartphone, tablet, or laptop. In some aspects, the connection may be wired, such as through use of an audio cable 130. In some implementations, headphones 125 may connect to the audio output jack of the interruption device 100.

In some aspects, an interruption device may be integrated into an audio source through software. A controller may run the software and also include other functionality pertaining to at least one of the audio source and the interruption device. As an illustrative example, many stores have automatic doors, which open when a person triggers a sensor. Adaptive software may be integrated into the door sensor to allow it to interface with the interruption device. As another illustrative example, a smartphone with an integrated interruption device may receive a message from a standalone motion sensor.

In some embodiments, a controller 105 may be integrated into the interruption device 100, wherein the controller 105 may allow a user to program the settings and manually control the audio levels, such as the interruption attenuation level. For example, the controller 105 may comprise a “thumbwheel” potentiometer. This controller 105 may allow the user to choose whether the music is completely attenuated (turns off completely), decreased in volume by a noticeable amount, or any user preference.

In some implementations, the interruption device 100 may further comprise a secondary notification 110, such as a visual cue (i.e. blip) or vibration. The secondary notification 110 may provide a confirmation of the status of the interruption device 100 or may provide different information. For example, the secondary notification 110 may indicate a solid red light for a manual mute and a flashing red light for a sensed motion. As another illustrative example, the secondary notification 110 may indicate the battery level of the interruption device 100. In some aspects, one or both of the interruption device 100 and the motion sensor 115 may employ audio-signal energy harvesting to reduce or eliminate the need for primary batteries.

In some embodiments, the secondary notification 110 may allow the user to visually confirm the power state, muting state, and mode of the device. In some aspects, the interruption device 100 may further comprise a beeper function, wherein the beeper could “peep” upon receipt of a motion event from the detector, which may provide the user an indication of motion 135 at the interruption device 100 even when there is no audio being played. The beeper may also provide useful feedback when changing modes.

For example, the secondary notification 110 may comprise a brief blip every 3 seconds to indicate that the interruption system is turned on (duty cycle chosen to conserve battery energy); one or more ½ second flashes ½ second apart to indicate the operating mode when the controller 105 is pressed and held to change mode. The pattern may only flash once each time the mode is changed. The secondary notification 110 may comprise a ¼ second on, ¼ second off flash to indicate the interruption system is in a timed mute state, wherein the interruption device 100 may automatically unmute after the configured interval, though a user may manually unmute by tapping button. The secondary notification 110 may comprise a 1 second on, 1 second off flash to indicate the audio is muted until the controller 105 is pressed, which may be entered by having the controller 105 manually tapped or by a detection of motion 135.

In some aspects, the motion sensor 115 may also detect external audio above a user specified sound pressure level. External audio detection may alert the user of an audio event that may not trigger a motion detection, such as a fire alarm, phone ring, or name recognition.

In some embodiments, the audio interruption device 100 may use an internal lithium polymer battery, which may have a battery life of approximately 30 hours. In some embodiments, the motion sensor 115 may use standard AA/AAA alkaline batteries. Depending on the how often the motion sensor 115 is activated, the batteries may last for 6 months to two years.

In some aspects, the motion sensor 115 may use a passive infrared motion sensor. The motion sensor 115 may wirelessly notify the audio interruption device 100. In some embodiments, the audio level may be completely muted, turned down a little bit, or turned way down. In some aspects, a user may also choose whether the audio automatically unmutes after 1 second, 5 seconds, or stays muted. When the motion sensor 115 senses motion 135, a notification is sent to the audio interruption device 100, which may then attenuate the audio. For example, depending on the chosen configuration, the audio may stay muted for 1 second, for 5 seconds, or until the controller 105 is pressed. This way, the user can either use the device as a brief heads up that someone is approaching, as a break in the music to have a chance to address the visitor, or as a way to insure that the music stays at a level conducive to whatever activity will be done with the visitor.

As another option, the motion sensor 115 may comprise a “curtain” sensor. Unlike a typical motion sensor, a curtain sensor may have a detection pattern that is skinny in one direction and wide in the other, which may allow motion detection across a very wide area or, in an alternate orientation, a small, thin area. A curtain sensor may more accurately detect a person walking through a small area in comparison to a person moving anywhere in the room. For example, a curtain sensor may be placed on the ground, at table height, or even mounted on the ceiling pointed down.

In some implementations, the interruption device 100 may be integrated into a 3.5 mm headphone extension cable or into headphones 125. The interruption device 100 may be integrated into a headphone amplifier, audio power (loudspeaker) amplifier, pre-amplifier, external digital to analog converter (specifically including devices where the input audio is via USB), digital audio player, powered (powered means amplifier-integrated in this context) loudspeaker or loudspeaker system, portable audio system. Alternately, the interruption device 100 may comprise a standalone tabletop device. In some aspects, the interruption device 100 may comprise a power switch, such as an on/off “slide” switch, which may allow a user to leave the interruption device 100 attached to the audio source even when use of the interruption device 100 may not be desired. In some embodiments, the motion sensor 115 may be designed to look like another innocuous object typical of the environment, such as a paper weight in an office, a track or strip embedded on the floor or ceiling tiles, or a rock outside an external door.

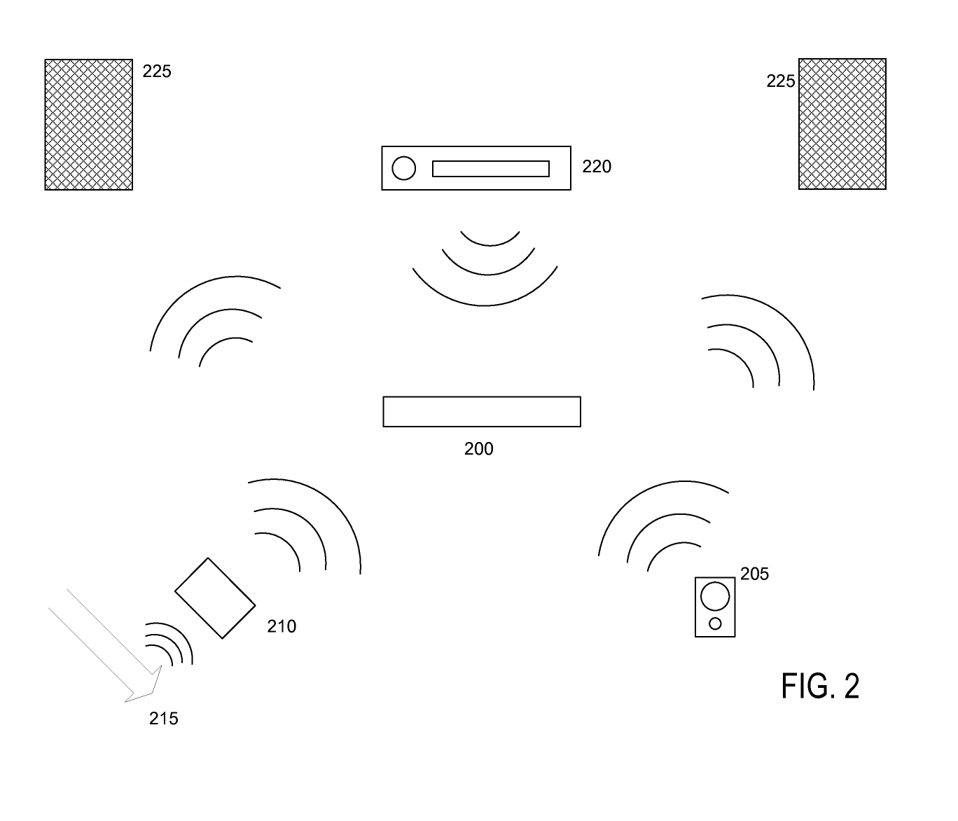

Referring now to FIG. 2, an alternate exemplary interruption system with motion sensor 210 is illustrated, wherein the interruption may occur wirelessly when motion 215 is sensed. In some aspects, an interruption system may comprise a wireless interruption device 200, motion sensor 210, and a remote controller 205. The wireless interruption device 200 may be paired with an audio source 220, such as a Bluetooth enabled stereo or television, wherein the audio source 220 is further paired with wireless audio output devices 225, such as speakers or headphones.

In some embodiments, the wireless interruption device 200 may intercept the audio that is originally transmitted from the audio source 220 to the audio output devices 225. The wireless interruption device 200 may separately pair with the audio source 220 and the audio output devices 225, wherein the pairing between the audio source 220 and the audio output devices 225 may not be necessary or desirable. Such a wireless system may be preferable over large areas, such as where the audio output devices 225 may be distant from the audio source 220.

Accordingly, a remote controller 205 may allow for convenient control over the interruption system. The remote controller 205 may allow a user to program the settings for the wireless interruption device 200, including, for example, the pairing controls, audio attenuation levels; the motion sensor 210, including, for example, the sensitivity levels, the detection area; and the secondary notifications, which may be located on one or more of the remote controller 205, the wireless interruption device 200, the motion sensor 210, audio output devices 225, or the audio source 220. For example, the wireless interruption device 200 may transmit original notification audio that may override the audio from the audio source 220 to the audio output devices 225.

In some embodiments, the remote controller 205 may allow a user to mute or unmute the music without being near the wireless or inline interruption device. A remote controller 205 may be preferable where the interruption device 200 may not be readily accessible, such as, for example, on a cable behind a computer, in a stereo cabinet, or integrated as part of a commercial audio installation. A remote controller 205 may also be preferable in applications where the user is roaming about a space, such as many retail or semi-industrial settings. The remote controller 205 may also be useful in some cases where the motion sensor 215 is not practical. For example, a user may hang the remote controller 205 outside his cubicle, allowing a passerby to cause an audio attenuation as a means to request the attention of the user. Alternately, a user may work in a professional environment where it is not appropriate to expect to be tapped on the shoulder to get the user's attention because the user may be listening to music through earbuds or headphones, and the interruption system may automatically mute the audio when someone enters the office or cubicle.

In some aspects, the motion sensor 215 may utilize one or more sensing technologies, such as PIR, microwave (i.e. radar or Doppler), active IR reflectivity sensing, electric field sensor, passive visible light sensor, active visible light sensor (light+reflector+receiver−“beam break”), pressure sensor (i.e. integrated into a door mat), active ultrasonic (transmit tone, listen for change in response since previous time), machine vision (camera plus processing), seismic detection, dual-element, direction-discriminating PIR (a class or PIR detectors that can sense whether someone is walking toward/away or left to right vs. right to left, which may be particularly useful where a user may only want to be notified when someone walks into a space but not when he exits.

In some embodiments, the interruption device 200 may attenuate the audio by being inline with a signal. Alternately, the interruption device 200 may attenuate the audio by sending an IR or RF remote control command to an existing piece of audio or audiovisual equipment, such as the preamplifier or integrated preamplifier and amplifier. For example, the interruption device may send the mute command to an AV receiver just as if it was the AV receivers IR remote control.

In some aspects, all portions of the interruption system, specifically including the motion detector intended to detect non-wearer humans, may be integrated into headphones. For example, a runner or person walking in a congested city may want their audio automatically attenuated as someone approaches within a defined vicinity, such as within four feet behind the user.

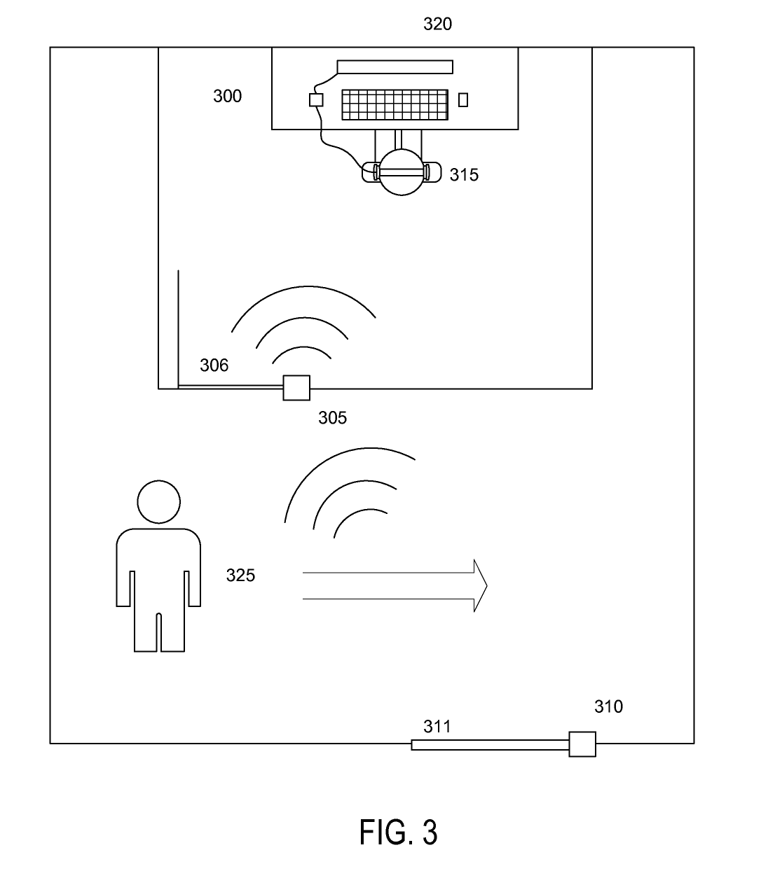

Referring now to FIG. 3, an exemplary interruption system with multiple motion sensors 305, 310 is illustrated. As described in FIGS. 1 and 2, the interruption system may comprise at least one motion sensor 305, 310 and an interruption device 300, which may comprise an integrated controller. The interruption device 300 may be connected to an audio source 320 and headphones 315 worn by a user.

In some aspects, each motion sensor 305, 310 may monitor difference detection areas 306, 311. For example, a user may station one motion sensor 305 at a doorway for an office and a second motion sensor 310 at an external door. In some aspects, the settings may be different for the different detection areas 306, 311. For example, the motion sensors 305, 310 may detect at different levels of sensitivity. The detection areas 306, 311 may comprise different size areas. Motion detection may trigger different levels of audio attenuation for the different detection areas 306, 311.

For example, motion 325 detected by the first motion sensor 305 may mute the audio until the user takes some action, whereas a motion detected by the second motion sensor 310 may only temporarily lower the volume of the audio. Similarly, motion 325 detected by the first motion sensor 305 may mute the audio in both ears, whereas a motion detected by the second motion sensor 310 may only mute the audio in one ear, which may allow a user to continue to enjoy the audio but with extended external awareness.

In some aspects, the interruption system may have an option that sends a message via an existing interface present on a cell phone, tablet, PC or other computing device, which may occur in conjunction with the audio attenuation or as a substitute. Software in the computing device may then perform an arbitrary command, such as, for example, “Mute”, “UnMute”,“Play”, “Pause”, and “Minimize”. The interface may include, but is not limited to, a headphone jack “third ring” remote control signals, headphone jack audio “impedance modulation” remote control signals, 802.11 (aka “wifi”), Bluetooth 4.0 (aka BLE, aka Bluetooth “Smart”).

As an example, the interruption device 300 may comprise a USB device that plugs into a personal computing device, wherein, based on alert transmissions from the motion sensors 305, 310, the interruption device 300 may send commands via USB to the audio source 320, such as a personal computing device, to have it perform arbitrary commands. The arbitrary commands may include “Mute”, “UnMute”, “Play”, “Pause” and “Minimize”.

In some aspects, the interruption device 300 may be integrated into the audio source 320 for a desktop or permanent installation use. As an integrated unit, the interruption device 300 may be line powered without requiring a separate power source. In some embodiments, the interruption device 300 may have increased RF range due to the presence of a more efficient antenna. In some aspects, an interruption system may further comprise door/window opening sensors or vibration sensors.

As an illustrative example, a person may work in a small office, some of the time the person may be the one who needs to know when UPS, FedEx, or a fire inspector arrives, for example. The person may not hear the lobby directly but we have an alarm that dings when the door is opened. Before this device the person may not have been able to listen to music at those times because the person could not hear the door, people or door alarm. The motion sensor may be placed on a table in the lobby. The second someone opens the lobby door the music mutes. The person may then either see or hear whether it is something that requires my attention or not. If it does not require attention, the person may tap the mute toggle button and continue listening.

As another illustrative example, a person may have a small home office and frequently work in the evening with headphone or speakers on. The person may have been reluctant to listen with headphones or speakers at his preferred volume because it would keep the person from hearing someone walk into the room. The motion sensor may be placed on an end table in the living room covering the space someone has to walk through to come into the room. The person may listen to music without worrying about being startled when someone tries to get attention.

As another illustrative example, a person may work in an auto parts store and may be allowed to have music in the back room but have to know when a customer comes in either door. There may be bells on the doors but they may not always be audible in the back with the music on. An interruption system with two sensors, such as illustrated in FIG. 3, may allow a person to put one by each of the doors. If the person is in the back and someone walks through the door, the person may know because the music gets real quiet for a second.

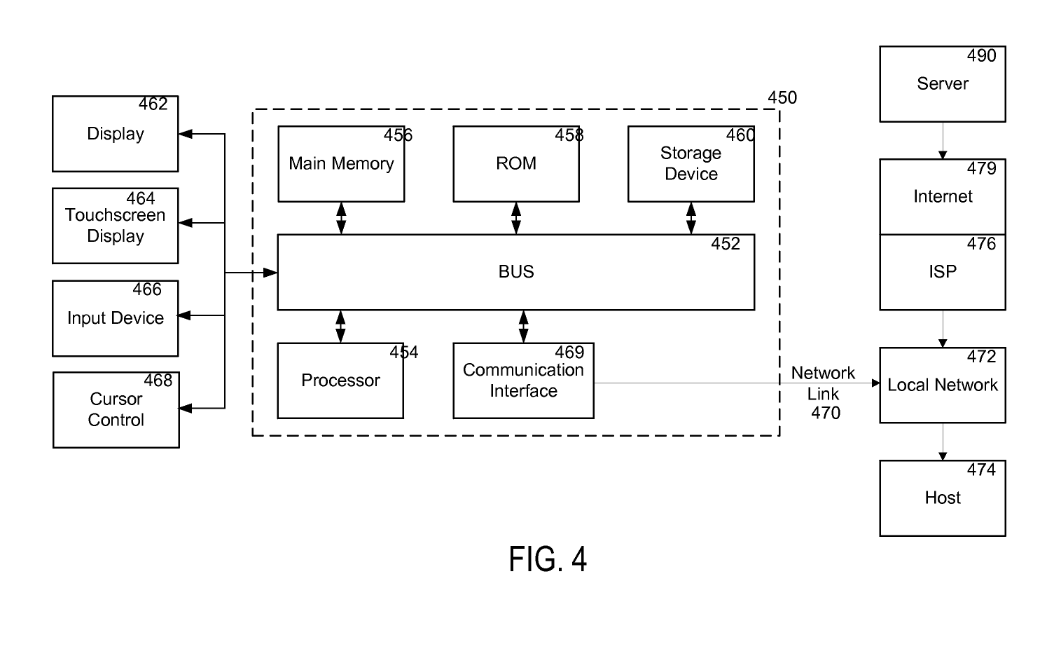

Referring now to FIG. 4, additional aspects of controller hardware useful for implementing the present invention are illustrated as a block diagram that includes a controller 450 upon which an embodiment of the invention may be implemented. Controller 450 includes a bus 452 or other communication mechanism for communicating information, and a processor 454 coupled with bus 452 for processing information.

Controller 450 also includes a main memory 456, such as a random access memory (RAM) or other dynamic storage device, coupled to bus 452 for storing information and instructions to be executed by processor 454. Main memory 456 may also be used for storing temporary variables or other intermediate information during execution of instructions to be executed by processor 454. Controller 450 further includes a read only memory (ROM) 458 or other static storage device 460.

Controller 450 may be coupled via bus 452 to a display 462, such as a cathode ray tube (CRT), liquid crystal display (LCD), plasma display panel (PDP), organic light-emitting diode (OLED), projector, or heads up display for displaying information to a computer user. An input device 466, including alphanumeric and other keys, may be coupled to bus 452 for communicating information and command selections to processor 454. Another type of user input device is cursor control 468, such as a mouse, a trackball, a touchpad, or cursor direction keys for communicating direction information and command selections to processor 454 and for controlling cursor movement on display 462. Another type of user input device is a touchscreen display 464 where a user may communicate information and command selections to processor 454 by tactile interaction with the display thereby controlling cursor movement or alphanumeric and other keys. This input device typically has two degrees of freedom in two axes, a first axis (e.g., x) and a second axis (e.g., y), that allows the device to specify positions in a plane.

According to some embodiment of the invention, layering system parameters are defined and managed by controller 450 in response to processor 454 executing one or more sequences of one or more instructions contained in main memory 456. Such instructions may be read into main memory 456 from another computer-readable medium, such as storage device 460. Execution of the sequences of instructions contained in main memory 456 causes processor 454 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 454 for execution. Such a medium may take many forms, including but not limited to, non-volatile media, volatile media, and transmission media. Non-volatile media includes, for example, optical or magnetic disks, such as storage device 460 and 458. Volatile media includes dynamic memory, such as main memory 456. Transmission media includes coaxial cables, copper wire and fiber optics, including the wires that comprise bus 452. Transmission media may also take the form of acoustic or light waves, such as those generated during radio wave and infrared data communications.

Common forms of computer-readable media include, for example, a memory stick, hard disk or any other magnetic medium, a CD-ROM, any other optical medium, a RAM, a PROM, and EEPROM, any other memory chip or cartridge, or any other medium from which a computer may read.

Various forms of computer readable media may be involved in carrying one or more sequences of one or more instructions to processor 454 for execution. For example, the instructions may initially be carried on a magnetic disk of a remote computer. The remote computer can load the instructions into its dynamic memory and send the instructions over a distributed network such as the Internet. A communication device may receive the data on the telephone line, cable line, or fiber-optic line and use an infrared transmitter to convert the data to an infrared signal. An infrared detector can receive the data carried in the infrared signal and appropriate circuitry can place the data on bus 452. Bus 452 carries the data to main memory 456, from which processor 454 retrieves and executes the instructions. The instructions received by main memory 456 may optionally be stored on storage device 460 either before or after execution by processor 454.

Controller 450 also includes a communication interface 469 coupled to bus 452. Communication interface 469 provides a two-way data communication coupling to a network link 470 that may be connected to a local network 472. For example, communication interface 469 may operate according to the internet protocol. As another example, communication interface 469 may be a local area network (LAN) card allowing a data communication connection to a compatible LAN. Wireless links may also be implemented.

Network link 470 typically provides data communication through one or more networks to other data devices. For example, network link 470 provides a connection through local network 472 to a host computer 474 or to data equipment operated by an Internet Service Provider (ISP) 476. ISP 476 in turn provides data communication services through the worldwide packet data communication network now commonly referred to as the “Internet” 479. Local network 472 and Internet 479 both use electrical, electromagnetic or optical signals that carry digital data streams. The signals through the various networks and the signals on the network link 470 and through communication interface 469, which carry the digital data to and from controller 450 are exemplary forms of carrier waves transporting the information.

In some embodiments, Controller 450 may send messages and receive data, including program code, through the network(s), network link 470 and communication interface 469. In the Internet example, a server 490 might transmit a requested code for an application program through Internet 479, ISP 476, local network 472 and communication interface 469.

Processor 454 may execute the received code as it is received, and/or stored in storage device 460, or other non-volatile storage for later execution. In this manner, controller 450 may obtain application code in the form of a carrier wave.

Access devices may include any device capable of interacting with controller or other service provider. Some exemplary devices may include a mobile phone, a smart phone, a tablet, a netbook, a notebook computer, a laptop computer, a wearable computing or electronic device, a terminal, a kiosk or other type of automated apparatus. Additional exemplary devices may include any device with a processor executing programmable commands to accomplish the steps described herein.

A controller may be a programmable board such as an arduino board, and/or one or more of: personal computers, laptops, pad devices, mobile phone devices, and workstations located locally or at remote locations, but in communication with the system. System apparatus can include digital electronic circuitry included within computer hardware, firmware, software, or in combinations thereof. Additionally, aspects of the invention can be implemented manually.

Apparatus of the invention can be implemented in a computer program product tangibly embodied in a machine-readable storage device for execution by a programmable processor and method actions can be performed by a programmable processor executing a program of instructions to perform functions of the invention by operating on input data and generating output. The present invention may be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired, and in any case, the language can be a compiled or interpreted language. Suitable processors include, by way of example, both general and special purpose microprocessors.

Generally, a processor will receive instructions and data from a read-only memory and/or a random access memory. Generally, a computer will include one or more mass storage devices for storing data files; such devices include magnetic disks, such as internal hard disks and removable disks magneto-optical disks and optical disks. Storage devices suitable for tangibly embodying computer program instructions and data include all forms of non-volatile memory, including, by way of example, semiconductor memory devices, such as EEPROM and flash memory devices ; magnetic disks such as, internal hard disks and removable disks; and CD ROM disks. Any of the foregoing can be supplemented by, or incorporated in, ASICs (application-specific integrated circuits).

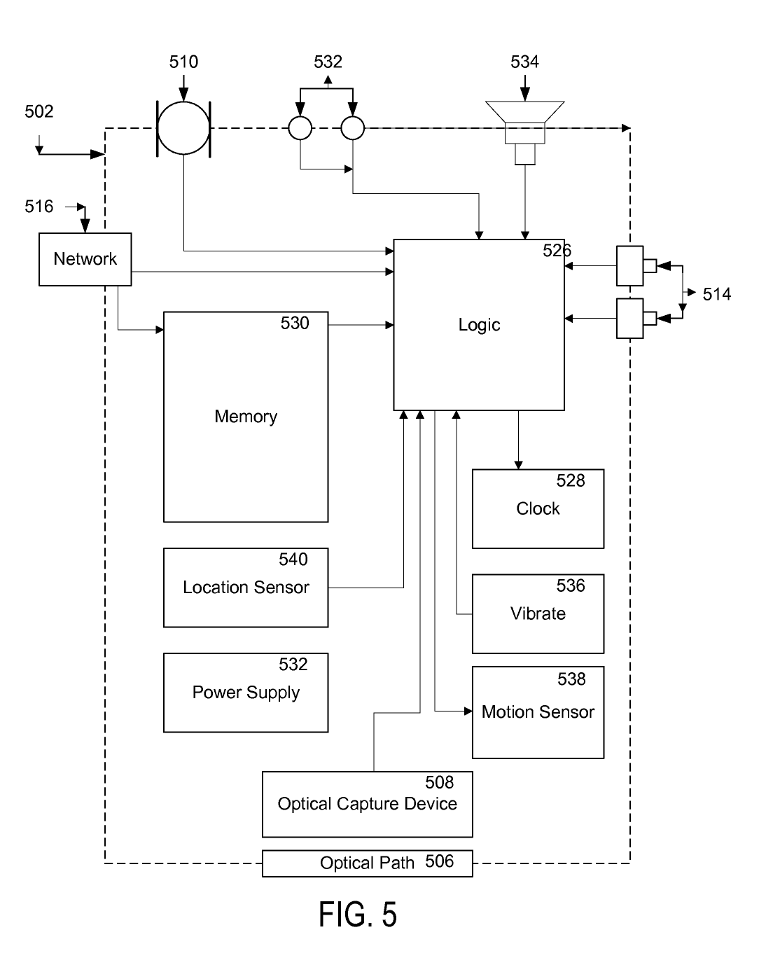

Referring now to FIG. 5, a block diagram of an exemplary embodiment of a mobile device 502 is illustrated. The mobile device 502 may comprise an optical capture device 508, which may capture an image and convert it to machine-compatible data, and an optical path 506, typically a lens, an aperture, or an image conduit to convey the image from the rendered document to the optical capture device 508. The optical capture device 508 may incorporate a Charge-Coupled Device (CCD), a Complementary Metal Oxide Semiconductor (CMOS) imaging device, or an optical sensor of another type.

In some embodiments, the mobile device 502 may comprise a microphone 510, wherein the microphone 510 and associated circuitry may convert the sound of the environment, including spoken words, into machine-compatible signals. Input facilities 514 may exist in the form of buttons, scroll-wheels, or other tactile sensors such as touch-pads. In some embodiments, input facilities 514 may include a touchscreen display. Visual feedback 532 to the user may occur through a visual display, touchscreen display, or indicator lights. Audible feedback 534 may be transmitted through a loudspeaker or other audio transducer. Tactile feedback may be provided through a vibration module 536.

In some aspects, the mobile device 502 may comprise a motion sensor 538, wherein the motion sensor 538 and associated circuitry may convert the motion of the mobile device 502 into machine-compatible signals. For example, the motion sensor 538 may comprise an accelerometer, which may be used to sense measurable physical acceleration, orientation, vibration, and other movements. In some embodiments, the motion sensor 538 may comprise a gyroscope or other device to sense different motions.

In some implementations, the mobile device 502 may comprise a location sensor 540, wherein the location sensor 540 and associated circuitry may be used to determine the location of the device. The location sensor 540 may detect Global Position System (GPS) radio signals from satellites or may also use assisted GPS where the mobile device may use a cellular network to decrease the time necessary to determine location. In some embodiments, the location sensor 540 may use radio waves to determine the distance from known radio sources such as cellular towers to determine the location of the mobile device 502. In some embodiments these radio signals may be used in addition to and/or in conjunction with GPS.

In some aspects, the mobile device 502 may comprise a logic module 526, which may place the components of the mobile device 502 into electrical and logical communication. The electrical and logical communication may allow the components to interact. Accordingly, in some embodiments, the received signals from the components may be processed into different formats and/or interpretations to allow for the logical communication. The logic module 526 may be operable to read and write data and program instructions stored in associated storage 530, such as RAM, ROM, flash, or other suitable memory. In some aspects, the logic module 526 may read a time signal from the clock unit 528. In some embodiments, the mobile device 502 may comprise an on-board power supply 532. In some embodiments, the mobile device 502 may be powered from a tethered connection to another device, such as a Universal Serial Bus (USB) connection.

In some implementations, the mobile device 502 may comprise a network interface 516, which may allow the mobile device 502 to communicate and/or receive data to a network and/or an associated computing device. The network interface 516 may provide two-way data communication. For example, the network interface 516 may operate according to an internet protocol. As another example, the network interface 516 may comprise a local area network (LAN) card, which may allow a data communication connection to a compatible LAN. As another example, the network interface 516 may comprise a cellular antenna and associated circuitry, which may allow the mobile device to communicate over standard wireless data communication networks. In some implementations, the network interface 516 may comprise a Universal Serial Bus (USB) to supply power or transmit data. In some embodiments, other wireless links known to those skilled in the art may also be implemented.

As an illustrative example of a mobile device 502, a reader may scan some text from a newspaper article with mobile device 502. The text is scanned as a bit-mapped image via the optical capture device 508. Logic 526 causes the bit-mapped image to be stored in memory 530 with an associated time-stamp read from the clock unit 528. Logic 526 may also perform optical character recognition (OCR) or other post-scan processing on the bit-mapped image to convert it to text. Logic 526 may optionally extract a signature from the image, for example by performing a convolution-like process to locate repeating occurrences of characters, symbols or objects, and determine the distance or number of other characters, symbols, or objects between these repeated elements. The reader may then upload the bit-mapped image (or text or other signature, if post-scan processing has been performed by logic 526) to an associated computer via network interface 516.

As an example of another use of mobile device 502, a reader may capture some text from an article as an audio file by using microphone 510 as an acoustic capture port. Logic 526 causes audio file to be stored in memory 528. Logic 526 may also perform voice recognition or other post-scan processing on the audio file to convert it to text. As above, the reader may then upload the audio file (or text produced by post-scan processing performed by logic 526) to an associated computer via network interface 516.

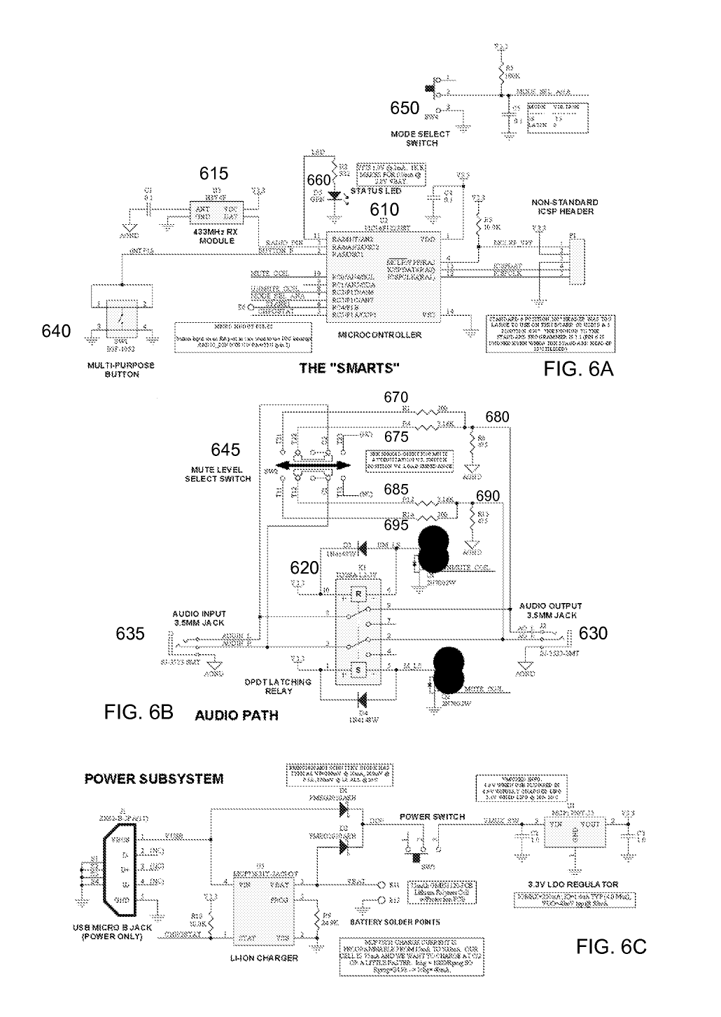

Referring now to FIGS. 6A-6C, exemplary circuit schematics for implementing the present invention are illustrated. The purpose of components shown in the figures, but not referenced in the text below, should be obvious to one practiced in the relevant art.

In some embodiments, the interruption device may comprise a 433 MHz OOK radio receiver module 615, which may receive an encoded signal from a PIR motion sensor, wireless button or other compatible wireless device. A suitable antenna, not shown, may be connected to the ANT port of the radio receiver module 615, which may demodulate the baseband signal from the RF carrier. In some aspects, the radio receiver module 615 may not decode the data and then may send the demodulated signal to a general-purpose 8-bit microcontroller 610.

The microcontroller 610 may receive encoded baseband data from the radio receiver module 615. When programmed with suitable firmware, the microcontroller 610 may recognize and decode transmissions from compatible wireless sensors. During initial setup, the microcontroller 610 may decode these transmissions for the purpose of “learning” the unique address of sensors it is intended to work with. In normal operation, the microcontroller 610 may be constantly listening to see if any data it receives is a valid transmission from one of the “learned” devices.

When the microcontroller 610 receives a message from one of the learned remote sensor devices, logic implemented in firmware selectively drives outputs to the status LED 660 and the latching relay coils 620. In the context of this circuit description, the word “mute” is used to mean either a partial or complete attenuation of the audio signal. Depending on the current state and the specific message received, the microcontroller 610 may control the latching relay coils 620 to either mute or unmute the audio. The status LED 660 indicates when the device is in the muted state.

The interruption system may comprise a momentary switch 640, wherein the state of the momentary switch 640 is monitored by the microcontroller 610. When the microcontroller 610 sees a valid press of the momentary switch 640, its internal firmware logic controls the state of the latching relay coils 620 to either mute or unmute the audio. The interruption system may comprise a mode selection switch 650, wherein logic in the microcontroller 610 may use the state of the mode selection switch 650 to determine how long to mute the audio for when a valid sensor signal is seen. The audio mute duration can range from less than one second to indefinite.

The interruption system may further comprise a connector 635, which may accept the input stereo audio signal. The audio signal received on the connector 635 is connected to both the latching relay 620 and a switchable resistor divider network comprising a switch 645 and resistive dividers 670-695.

The switch 645 may select the “muted” attenuation level, and there may be three active positions on the switch 645. In the first position, the audio is attenuated a relatively small amount via the resistive dividers 675, 680, 690, 695. In the second position, the audio is attenuated by a significantly larger amount by the resistive dividers 675, 680, 690, 695.

The latching relay coils 620 may allow the microcontroller 610 to control whether the input audio must pass through the selectable resistor divider or is shunted directly to the audio output connector 630.

### CONCLUSION

A number of embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

1. An interruption system with a motion sensor comprising:
an audio interruption device paired with an audio source, the audio interruption device configured to interrupt or attenuate an audio output signal generated by the audio source, wherein the interruption or attenuation affects the audio output signal independent from the audio device; and
a first motion sensor comprising a curtain sensor configured to detect motion in a predefined area based upon a location of the curtain sensor, said detection is in a predetermined wider area in a first direction relative to a location of the sensor and in a predetermined more narrow direction in a second direction relative to the location of the curtain sensor and within a predefined distance of the first motion sensor, said first motion sensor comprises, or is in electrical communication with, a transmitter and configured to transmit a motion notification to the interruption device based upon an electrical communication from the first motion sensor, wherein the motion notification causes the interruption device to attenuate the audio output signal.

2. The interruption system of claim 1, wherein the interruption system further comprises: an antenna coupled to a 433 Mhz radio receiver, and that receives an encoded signal from the transmitter based upon input to the transmitter from a PIR sensor; a radio receiver module that demodulates a baseband signal from an RF carrier; a microcontroller receiving encoded data comprising the demodulated baseband signal, said microcontroller recognizing and decoding data from compatible sensors and driving outputs to: one or more latching relay coils that attenuate the audio signal, and one or more light emitting diodes.

3. The interruption system of claim 2, wherein the interruption system further comprises a connector for receiving the audio output signal and connecting the audio output signal to the latching relay coils and a switchable resistor network comprising a switch and resistive dividers, the switch comprising multiple active positions, each active position of the switch attenuating the audio output signal in a different amount by the dividers.

4. The interruption system of claim 3, wherein the status indicator comprises an audio indicator configured to interject a second audio signal into the audio output signal based on an occurrence of the predefined event.

5. The interruption system of claim 3, wherein the status indicator comprises a visual indicator configured to provide a visual cue based on an occurrence of the predefined event.

6. The interruption system of claim 3, wherein the status indicator comprises a vibration device configured to vibrate based on an occurrence of the predefined event.

1. al) The interruption system of claim 1, wherein a user defines configuration settings of the interruption system.

8. The interruption system of claim 1, wherein the interruption device is integrated into a 3.5 mm headphone extension cable.

9. The interruption system of claim 1, wherein the interruption device is integrated into headphones configured to receive the audio output signal of the electronic device.

10. The interruption system of claim 1, wherein the attenuation occurs inline with the audio output signal.

11. The interruption system of claim 1, wherein the attenuation occurs wirelessly from the electronic device.

12. The interruption system of claim 1, wherein the interruption device further comprises a manual audio control configured to manually attenuate the audio output signal of the electronic device, wherein the manual attenuation affects the audio output signal independent from the electronic device, and wherein the manual audio control overrides the attenuation prompted by the motion notification.

13. The interruption system of claim 1, wherein a level and duration of the attenuation of the audio output signal comprises an adjustable setting.

14. The interruption system of claim 1, wherein the interruption device is integrated into the electronic device.

15. The interruption system of claim 14, wherein the electronic device comprises a smartphone.

16. An interruption system with a sensor comprising:
an interruption device comprising an encoded receiver for receiving a wireless 433 MHz signal comprising an access code and configured to attenuate an audio output signal of an electronic device based upon the wireless signal, wherein the attenuation affects the audio output signal independent from the electronic device; and
a first sensor configured to detect an interruption of a light beam in a predefined area based upon a location of the curtain sensor, said detection is in a predetermined area that is wider in a first direction relative to a location of the sensor and more narrow in a second direction relative to the location of the curtain sensor and, said first sensor in logical communication with a transmitter configured to wirelessly transmit a notification via an encoded signal to the encoded receiver included in the interruption device, said transmission of the notification is based upon the detected interruption of the light beam, wherein the notification causes the interruption device to attenuate the audio output signal.

17. The interruption system of claim 16, further comprising a second sensor configured to detect one or more of motion, audio, pressure, or light within a second predefined distance of the second sensor and configured to transmit a second notification to the interruption device, wherein the second notification causes the interruption device to attenuate the audio output signal.

18. The interruption system of claim 17, wherein the first sensor and the second sensor detect a same set of one or more of motion, audio, pressure, or light.

19. The interruption system of claim 17, wherein the first sensor and the second sensor detect a different set of one or more of motion, audio, pressure, or light.

20. The interruption system of claim 17, wherein a user defines configuration settings of the first sensor and the second sensor, wherein the first sensor and the sensor are configurable separately.
